(19) United States
(12) Patent Application Publication
(10) Pub. No.: US 2007/0000887 A1
(43) Pub. Date: Jan. 4, 2007

(54) Method for scan welding or marking through a waveguide and waveguide therefor

(76) Inventors: Scott Caldwell, Rochester, NY (US); Paul Rooney, Henrietta, NY (US); Hugh McNair, Webster, NY (US)

Correspondence Address: HARNESS, DICKEY & PIERCE, P.L.C., P.O. BOX 828, BLOOMFIELD HILLS, MI, 48303, US

(21) Appl. No.: 11/170,570

(22) Filed: Jun. 29, 2005

(51) Int. Cl. B23K 26/06; B23K 26/20

(52) U.S. Cl. 219/121.73; 219/121.64; 219/121.69; 219/121.8

(57) ABSTRACT

An optical scan system welds or marks a part by directing an optical beam onto the part at a sufficient energy density level to weld or mark it. A method of controlling a pattern where the part is to be exposed to the beam at the sufficient energy density level includes disposing a waveguide between the part and an optical source of the optical scan system to prevent areas of the part that are not to be welded or marked from being exposed to the beam at the sufficient energy density level to weld or mark them, allowing the areas to be welded or marked to be exposed to the beam at the sufficient energy level. In an aspect, the waveguide prevents the beam from being reflected in an undesired direction. In an aspect, the waveguide redirects the beam from the areas of the part that are not to be welded or marked to areas that are to be welded or marked to concentrate the energy on the areas to be welded or marked. In an aspect, a dissipative waveguide dissipates energy of the beam in the areas of the part that are not to be welded or marked so that those areas are not exposed to the beam at the sufficient energy density level.

### FIELD OF THE INVENTION

The present invention relates to optical scan welding or marking, and more particularly, to optical scan welding or marking using a waveguide.

### BACKGROUND OF THE INVENTION

Optical scan welding or marking, often referred to as light scan welding or marking, involves scanning an optical beam (visible frequency or otherwise) over material to be welded or marked. The optical beam is produced by an optical system, and is illustratively in the infrared spectrum. It should be understood that the optical beam could also be in the visible or ultraviolet spectrum. Lasers are often used for scan welding or marking. Non-coherent light sources are also used. Optical beam can be an infrared beam, visible beam or ultraviolet beam.

In optical scan welding, material, such as material of two parts to be welded, is heated by the optical beam and flows together to join the two parts once the material hardens. In optical scan marking, an area of a part to be marked is heated by the optical beam to remove material from the part and thus marking the part. The beam can be narrow (narrow beam scanning) or wide (wide beam scanning). The beam can write a pattern (where the welding or marking is to occur) directly on the part or a mask used to control the pattern. In the latter case, a mask is disposed on the material being welded or marked so that only the portion of the material that is to be welded or marked is exposed to the optical beam. Depending on the nature of the mask, the mask either absorbs or reflects the energy of the optical beam so that the portions of the material that are not to be welded or masked are not exposed to the optical beam. One of the problems exhibited by reflective masks is that they may reflect the optical beam in an undesired direction, such as back into the optical system of the optical scan system.

### SUMMARY OF THE INVENTION

An optical scan system welds or marks a part mark by directing an optical beam onto the part at a sufficient energy density level to weld or mark it. A method of controlling a pattern where the part is to be exposed to the beam at the sufficient energy density level includes disposing a waveguide between the part and an optical source of the optical scan system to prevent areas of the part that are not to be welded or marked from being exposed to the beam at the sufficient energy density level and allow those areas of the part to welded or marked to be exposed to the beam at the sufficient energy density level.

In an aspect, the waveguide is used to prevent the beam from being reflected in an undesired direction.

In an aspect, the waveguide redirects the beam from the areas of the part that are not to be exposed to the beam at the sufficient energy density level and to the areas that are to be exposed to the beam at the sufficient energy density level to concentrate energy of the beam in those areas.

In an aspect, the waveguide is a dissipative waveguide that dissipates energy of the beam in the areas of the part that are not to be welded or marked so that an energy density level of the beam in those areas is below the sufficient energy density level.

In an aspect, the waveguide is a positive or a negative waveguide.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of an optical scan system using a negative waveguide in accordance with an aspect of the invention;

FIG. 2 is a schematic view of an optical scan system using a positive waveguide in accordance with an aspect of the invention;

FIG. 3 is a schematic view of an optical scan system using a waveguide to direct a beam out of the waveguide in accordance with an aspect of the invention; and

FIG. 4 is a schematic view of an optical scan system using a dissipative waveguide in accordance with an aspect of the invention.

### DETAILED DESCRIPTION OF THE PREFERRED EMBODIMENTS

The following description of the preferred embodiment(s) is merely exemplary in nature and is in no way intended to limit the invention, its application, or uses.

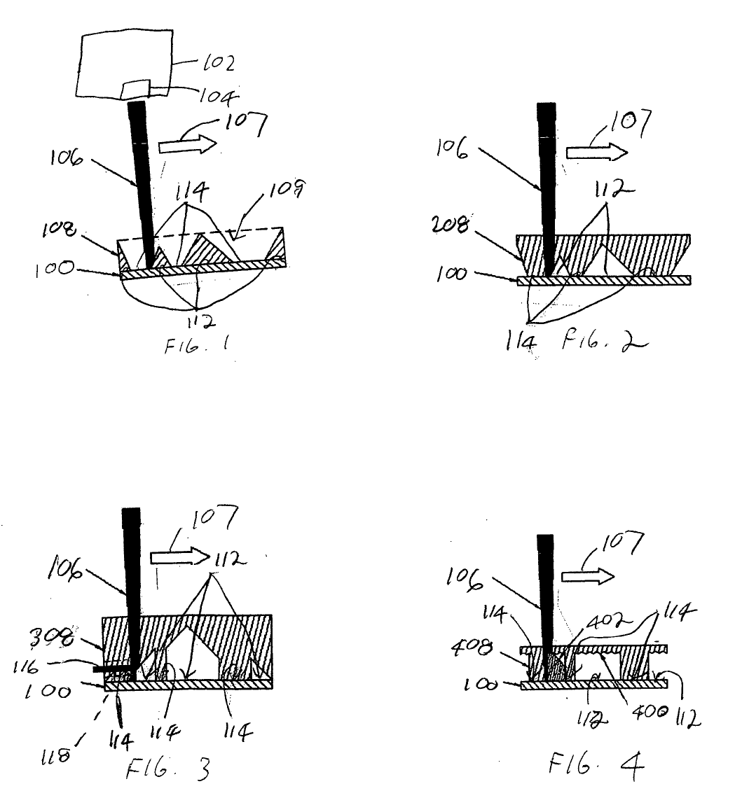

Referring to FIG. 1, in accordance with the invention, a part 100 is welded or marked using a wide or narrow beam optical scan system 102. In this regard, optical scan system 102 directs an optical beam 106 onto the part at a sufficient energy density level to heat a pattern on part 100 to a level so that material of the part 100 in the pattern either flows together in the case of welding or is removed in the case of marking. In the case of optical scan welding, part 100 may include two parts 100 that are welded together. Optical scan system 102 has an optical source 104 (such as a laser or non-coherent source) that produces beam 106 (visible or other frequency). A waveguide 108 is juxtaposed between part 100 and optical scan system 102, illustratively on part 100, and controls a pattern on part 100 to be welded or marked.

Beam 106 is scanned across part 100, illustratively in the direction shown by arrow 107. Waveguide 108 has an output face 109 shaped to provide the desired pattern to be welded or marked on part 100. Waveguide 108 directs the beam 106 away from the areas 112 of part 100 that are not to be welded or marked and to the areas 114 of part 110 that are to be welded or marked. Areas 114 are thus exposed to beam 106 at an energy density level sufficient to weld or mark the part 100 in areas 114 and areas 112 are not. In the embodiment of FIG. 1, waveguide 108 is a negative waveguide, that is, it reflects beam 106 away from the areas 112 of part 100 that are not to be exposed to beam 106 at the sufficient energy density level and to the areas 114 of part 110 that are to be exposed to beam 106 at the sufficient energy density level. In this regard, waveguide 108 may illustratively be a hollow reflective waveguide.

With reference to FIG. 2, a positive waveguide 208 is utilized instead of negative a waveguide. Similar to the negative waveguide, positive waveguide 208 directs beam 106 away from areas 112 and to the areas 114. It does so by focusing beam 106 on the areas 114 (as opposed to reflecting beam 106 as in the case of a negative waveguide). In this regard, positive waveguide 208 may illustratively be a transmissive dielectric.

In the embodiments of FIGS. 1 and 2, beam 106 is redirected to areas 114 of part 100 when it is directed away from the areas 112 of part 100. This increases the concentration of energy on areas 114 of part 100. It also avoids beam 106 from being reflected in an undesired direction, such as back into the optical system of optical scan system 102.

Alternatively, the beam 106, when it is redirected away from areas 112 of part 100, can simply be redirected away from the areas 112 and not redirected to the areas 114. With reference to FIG. 3, a waveguide 308 is shaped to redirect beam 106 away from areas 112 of part 100 so that a redirected portion 116 of beam 106 exits waveguide 308, but does not redirect beam 106 to areas 114,. In this regard, waveguide 308 can be provided with one or more fiber optic elements 118 (shown in phantom in FIG. 3) to redirect portion 116 of beam 106 out of waveguide 308. This allows the redirected portion of beam 106 to be redirected in a desired direction, such as away from the optical system of optical scan system 102.

In another variation, the waveguide is a dissipative waveguide and dissipates or disperses the energy of beam 106 in the areas 112 of part 100 that are not to be welded or marked to an energy density below that of the welding or marking threshold, as applicable. With reference to FIG. 4, waveguide 408 includes a dissipative or dispersive feature(s) 400 that dissipates or disperses the energy of beam 106 in the areas 112 of part 100 that are not to be welded so that the energy of a portion 402 of beam 106 in areas 112 of part 100 are below the energy density threshold for welding or marking, as applicable. Dissipative or dispersive feature(s) 402 may include, by way of example and not of limitation, faceting, lensing, and/or surface frosting. This variation also avoids beam 106 from being reflected in an undesired direction, such as back into the optical system of optical scan system 102.

Optical scan welding in which the waveguide(s) as described above can be used includes through transmission infrared (TTIR) welding. In TTIR welding, a part made of transmissive (to an infrared laser beam) material is welded to a part made of absorbtive (to the infrared laser beam) material. The two parts are placed together with the part made of transmissive material closest to the source of the infrared laser beam. When the infrared laser beam is directed to the parts, it passes through the part made of the transmissive material into the part made of the absorptive material, heating the part made of the absorptive material. The part made of absorptive material is heated to the point where the material flows and bonds to the material of the part made of the transmissive material.

Use of a waveguide in optical scan systems that weld or mark parts, as described with reference to FIGS. 1-4, provides better image quality than can be achieved with direct beam writing. The waveguide also more efficiently uses the energy from the beam than a mask.

The description of the invention is merely exemplary in nature thus, variations that do not depart from the gist of the invention are intended to be within the scope of the invention. Such variations are not to be regarded as a departure from the spirit and scope of the invention.

What is claimed is:

1. A method of welding or marking a part with an optical scan system that directs an optical beam onto the part at an energy density level sufficient to weld or mark it, comprising controlling a pattern of the beam on the part by disposing a waveguide between the part and an optical source of the optical scan system to prevent areas of the part that are not to be exposed to the beam at the sufficient energy density level from being exposed to the beam at the sufficient energy density level and to prevent the beam from being reflected in an undesired direction.

2. The method of claim 1 including redirecting the beam with the waveguide away from the areas of the part that are not to be exposed to the beam at the sufficient energy density level and to the areas of the part that are to be exposed to the beam at the sufficient energy density level to concentrate energy on those areas of the part.

3. The method of claim 2 wherein the waveguide is a negative waveguide.

4. The method of claim 2 wherein the waveguide is a positive waveguide.

5. The method of claim 1 including redirecting the beam with the waveguide away from the areas of the part that are not to be exposed to the beam at the sufficient energy density level and out of the waveguide.

6. The method of claim 1 wherein the waveguide is a dissipative waveguide and the method includes dissipating energy of the beam with the waveguide in the areas of the part that are not to be exposed to the beam at the sufficient energy density level so that energy of the beam in those areas is below the sufficient energy density level.

7. The method of claim 1 where the optical scan system is a laser scan system and the optical beam is a laser beam.

8. The method of claim 1 wherein the part includes two parts that are to be welded together and the method includes through transmission infrared welding the two parts together.

9. The method of claim 1 where the optical beam is a non-coherent beam.

10. A method of welding or marking a part with a laser scan system that directs a laser beam onto the part at an energy density level sufficient to weld or mark it, comprising controlling a pattern of the beam on the part by disposing a waveguide between the part and an optical source of the laser scan system to redirect a laser beam from areas of the part that are not to be exposed to the beam at the sufficient energy density level to areas of the part that are to be exposed to the beam at the sufficient energy density.

11. The method of claim 10 including redirecting the beam with the waveguide so as to prevent it from being reflected in an undesired direction.

12. The method of claim 11 wherein the waveguide is a negative waveguide.

13. The method of claim 11 wherein the waveguide is a positive waveguide.

14. The method of claim 10 including redirecting the beam with the waveguide away from the areas of the part that are not to be exposed to the beam at the sufficient energy density level and out of the waveguide.

15. The method of claim 9 wherein the part includes two parts that are to be welded together and the method includes through transmission infrared welding the two parts together.

16. A method of welding or marking a part with a laser scan system that directs a laser beam onto the part at an energy density level sufficient to weld or mark it, comprising controlling a pattern of the beam on the part by disposing a dissipative waveguide between the part and a laser source of the laser scan system to dissipate energy of the beam with the waveguide in areas of the part that are not to be exposed to the beam at the sufficient energy density level.

17. The method of claim 16 including preventing with the waveguide the beam from being reflected in an undesired direction.

18. The method of claim 16 wherein the part includes two parts that are to be welded together and the method includes through transmission infrared welding the two parts together.
